(19) United States
(12) Patent Application Publication
(10) Pub. No.: US 2024/0273077 A1
(43) Pub. Date: Aug. 15, 2024

(54) Fine-Grained Custom Sharding Of Databases

(71) Applicant: Oracle International Corporation, Redwood Shores, CA (US)

(72) Inventors: Zheng Zeng, Foster City, CA (US); Lin Lu, San Jose, CA (US); Mark Dilman, San Carlos, CA (US); Wei-Ming Hu, Palo Alto, CA (US); Ghazi Nourdine Benadjaoud, Pleasanton, CA (US); Leonid Novak, Castro Valley, CA (US); Darshan Maniyani, Union City, CA (US)

(21) Appl. No.: 18/400,412

(22) Filed: Dec. 29, 2023

Related U.S. Application Data
(60) Provisional application No. 63/436,233, filed on Dec. 30, 2022.

(51) Int. Cl. G06F 16/22; G06F 16/27

(52) U.S. Cl. CPC G06F 16/2282; G06F 16/27

(57) ABSTRACT

Under dynamic shard mapping, applications may dynamically define, evolve, and redefine how a sharded table is sharded across shards according to sharding keys. Dynamic shard mapping is referred to as being dynamic because changes to a sharding directory that defines a sharding distribution scheme are effected without having to change synchronized f metadata. A sharding directory maps sharding key values to shard servers. The changes are effected directly by invoking an API or indirectly by submitting a DML command that includes, for example, a sharding key value that is unmapped by the sharding directory. The sharding directory is distributed among the shards and client computers of a sharded DBMS to facilitate and optimize the routing of database commands across the shards of a DBMS.

### RELATED APPLICATIONS

The present application claims priority to U.S. Provisional Patent Application No. 63/436,233, entitled Fine-Grained Custom Sharding of Relational Databases, filed on Dec. 30, 2022 by Zheng Zeng, et al., the entire contents of which are incorporated herein by reference.

### FIELD OF THE INVENTION

The present disclosure relates to sharded database management systems (sharded DBMSs).

### BACKGROUND

Database systems that store increasingly large amounts of data are becoming more and more prevalent. For example, online transaction processing (OLTP) systems, such as e-commerce, mobile, social, and Software-as-a-Service (SaaS) systems, typically require large database storage. Example applications for OLTP systems include but are not limited to, large billing systems, ticketing systems, online financial services, media companies, online information services, and social media companies. Given the significant amount of data stored by these database systems, storing all the data on a single database instance may be impractical, as storing that amount of data can utilize significant computing resources, such as processors, memory, and storage.

Horizontal partitioning is a technique of decomposing a single larger database object into smaller, more manageable subsets of information called “partitions.” Sharding is a data tier architecture where a database object is horizontally partitioned across independent database servers and where each independent database server is referred to as a “shard server” or “shard.” A collection of shard servers, together, may be referred to as a sharded DBMS. A sharded DBMS may comprise multiple DBMSs, each of which comprises one or more database servers that may be referred to as a shard server of the sharded DBMS. Logically, a sharded DBMS can be accessible to a client application just like a traditional unsharded DBMS. However, database objects in a sharded database are horizontally partitioned across shards.

A client application may need to be programmed for specific lower-level details (be “shard aware”) needed to manage and access shards in a sharded DBMS. To modify a sharded database, the client application generates database commands needed to add records to each shard and routes the database commands to the respective shards. To query a sharded DBMS, a client application generates database commands needed to access each shard, directs the database commands to each shard, and merges results returned by the shards.

The need to design client applications to route database commands to appropriate shards is avoided using an approach referred to herein as DBMS-managed sharding. Under this approach, a client application is not configured with the lower-level details of directing database commands to shards; instead the sharded DBMS handles the lower-level details needed to access the shards. To query or modify a sharded database, the client application simply submits a database command to the sharded DBMS, which may then generate the needed database commands to send to respective shards within the sharded DBMS.

### DBMS-Managed Sharding

In DBMS-managed sharding, a sharded DBMS manages the distribution of data between shards in a sharded database using a variety of approaches. The approaches are referred to herein as the system-managed approach, the schema-mapped approach, and the composite approach. The approaches are key-driven in that they divide database records of a database object into shards according to attributes of records referred to herein as sharding keys. The way data is distributed among the shards is referred to as a sharding distribution schema.

Under the system-managed approach, the sharding distribution schema is random. The sharded DBMS randomly distributes data among shards by applying a hash algorithm to sharding keys to attempt to achieve a uniform distribution automatically. System-managed sharding is optimal for the use case where there is a large amount of data associated with a large set (at least in the millions) of sharding key values and an even distribution of data across sharded databases is desired. The users leave control of data location to the sharded DBMS. Generally, a good uniform distribution can be achieved with 10 million sharding key values, while a distribution with 1-10 million values is acceptable. When the number falls below 1 million, the results are often skewed and uneven.

Under the schema-mapped approach, the user specifies in detail a sharding scheme distribution. Specifically, the user specifies the shard for each sharding key value (list-based) or each sharding key value range (range-based) at schema creation time. This approach gives the user control over the distribution of the data for individual keys or key ranges to achieve data balance across shards. New key values or value ranges can be added later, but it is a very infrequent event and a time-consuming operation, as shall be explained in more detail. Schema-mapped sharding is optimal for the use case where there is a small, mostly known static set of key values or value ranges (up to hundreds) that the user prefers to have specific location control over.

Composite sharding is, in effect, a combination of the schema-mapped and system-managed approach. At a higher level, the shards are divided into sets of shards “shard spaces”. The user specifies the shard space for each sharding key value (list-based) or each value range (range-based) at schema creation time. At the second lower level, within each shard space, data is distributed among the shards in the shard space as in the system-managed approach. Composite sharding is optimal for various use cases where the data is divided at a higher level into subsets based on a preferred geographic location or hardware resources or different high availability and database recovery configurations, where the number of divisions is small and known at initial schema creation time.

The approaches for dividing data into shards under the DBMS-managed sharding have disadvantages that make them less than optimal for various use cases. The system-managed approach deprives the user of control over data distribution. There are many use cases where users have knowledge of correlations between sharding key values that correspond to an affinity between records of different database objects. Records have affinity when accessed together at the same location and/or more or less concurrently. The lack of control over the distribution of data deprives users of the ability to exploit this knowledge. In addition, good uniform distribution may not be achieved when the number of sharding key values is too small.

The schema-mapped approach does not scale very well. The schema-mapped approach requires creating and modifying a schema using, for example, data definition language (“DDL”) database commands. Using DDL database commands to define an extensive mapping between sharding key values can be very tedious and time consuming.

In addition, making changes to the mapping to change a sharding distribution schema requires making changes to metadata in a database dictionary that requires serialization with the database transactions, which can entail significant overhead and delay for each change. Specifically, such serialization requires that there be no inflight database transactions (database transactions not yet committed or rolled back) when the change to the metadata in the database dictionary is changed. This may be accomplished by issuing a DDL lock in a DBMS, which prevents the initiating of new database transactions in the DBMS. Once the inflight database transactions that had been executing terminate (e.g., are committed or rolled back), the change to the metadata in the database dictionary is made and then the DDL lock is released or otherwise terminated.

Preventing the initiating of new database transactions and waiting for the completion of inflight database transactions is highly disruptive to DBMS performance and availability. Schema metadata in a database dictionary to which changes may require serialization with database transactions is referred to herein as serialized schema metadata.

Finally, the composite approach suffers the disadvantages discussed above that are attendant system-managed and schema mapped approaches.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a diagram depicting a sharded DBMS according to an embodiment of the present invention.

FIG. 2 is a diagram depicting the organization of a family of sharded tables according to an embodiment of the present invention.

FIG. 3 is a diagram depicting distributed sharding directory according to an embodiment of the present invention.

FIG. 4 is a diagram depicting a database connection pool on a client computer according to an embodiment of the present invention.

FIG. 5 is a diagram depicting approaches for dynamic sharding mapping according to an embodiment of the present invention.

FIG. 6 is a diagram depicting approaches for dynamic shard key remapping according to an embodiment of the present invention.

FIG. 7 is a diagram depicting approaches for performing partition pruning according to an embodiment of the present invention.

FIG. 8 is a diagram depicting a computer system that may be used to implement an embodiment of the present invention.

FIG. 9 depicts a software system that may be employed for controlling the operation.

### DETAILED DESCRIPTION

In the following description, for the purposes of explanation, numerous specific details are set forth in order to provide a thorough understanding of the present invention. It will be apparent, however, that the present invention may be practiced without these specific details.

### General Overview

Described herein is an approach to sharding referred to herein as dynamic shard mapping. Under dynamic shard mapping, applications may dynamically define, evolve, and redefine how a sharded table is sharded across shards according to sharding keys.

Dynamic shard mapping is referred to as being dynamic because a sharding distribution schema can be set up or changed without having to change synchronized schema metadata. Specifically, the sharding directory includes entries that map sharding key values to shards. The entries are not stored as synchronized metadata. To change a sharding schema distribution, sharding directory entries are added or changed in the sharding directory. Because entries in the sharding directory are not stored as serialized schema metadata, the overhead attendant to changing serialized schema metadata to change a sharding distribution scheme is avoided. Such overhead prevents greater customization and evolution of a sharding distribution schema. With dynamic shard mapping, the elimination of this overhead renders feasible greater customization and evolution of a sharding distribution scheme.

Entries in a sharding directory are added or changed directly by invoking an API or indirectly by submitting a DML command that includes, for example, a sharding key value that is unmapped by the sharding distribution scheme. The sharding directory is distributed among the shards and client computers of a sharded DBMS to facilitate and optimize the routing of database commands across the shards of a DBMS.

Dynamic shard mapping is described in the context of a DBMS that supports a relational database, where a collection of records is stored as rows in a table. However, dynamic sharding mapping may be employed in DBMSs that support other kinds of databases, such as a document DBMS (“DOCs”), in which a collection of records is stored as a collection of documents marked up in a hierarchical markup language, such JSON or XML.

### Sharded DBMS

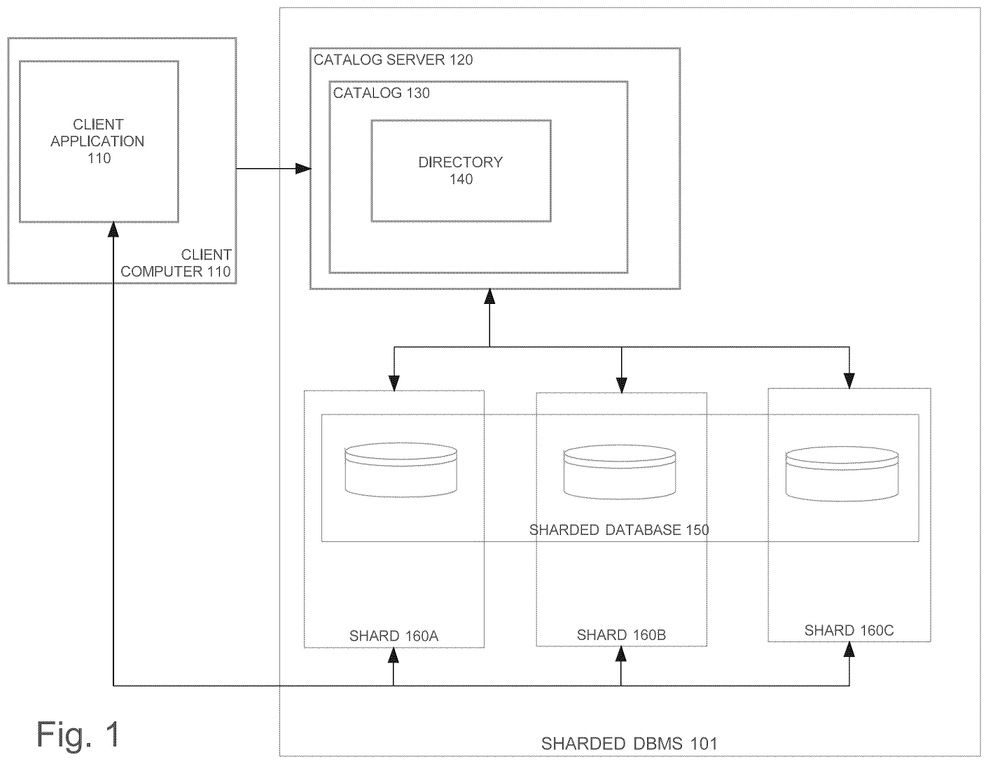

FIG. 1 is a block diagram of sharded DBMS 101, a sharded DBMS according to an embodiment of the present invention. A sharded DBMS may include any number of shards, and the number of shards in a sharded DBMS may vary over time. Each of shards 160A, 160B, and 160C may be its own database server that does not need to share physical resources, such as processors, memory, and/or storage devices, with other shards in the sharded database 150. Sharded DBMS 101 may comprise multiple DBMSs each with multiple database servers. Each of the multiple DBMSs may comprise one or more of shards 160A, 160B, and 160C.

Tables in sharded database 150 are horizontally partitioned across shards 160A, 160B, and 160C. The manner in which the tables are sharded across these shards is described later. Shards 160A, 160B, and 160C are collectively referred to as shards 160.

Catalog server 120 is a special database server that coordinates various functionalities across shards 160A, 160B, and 160C and that stores configuration data for the sharded DBMS 101. The various functionalities coordinated by catalog server 120 include routing database commands to shards, propagating database schema changes to shards, monitoring the status of shards, receiving status updates from shards, receiving notifications from client applications, sending notifications to shards, sending notifications to client applications, and/or coordinating various operations that affect the configuration of the sharded database 150, such as resharding operations.

Configuration data of sharded DBMS 101 is stored in catalog 130 and may include shard topology data, the configuration of the shards 160A, 160B, and 160C, and information about the client application 110. Catalog 130 includes sharding directory 140. Sharding directory 140 maps which shard stores which portions of a sharded table that corresponds to respective sharding key values, ranges of sharding key values. Sharding directory 140 is replicated across shards 160A, 160B, and 160C and client computers of shard DBMS 101, as described later in greater detail. A sharding directory in a catalog server and copies of the sharding directory that are replicated across the shards of a sharded DBMS and client computers of the sharded DBMS are collectively referred to herein as a distributed sharding directory.

Client application 110 is an application running on client computer 110. Client application 110 is any sort of client application that requires access to data stored in a database.

### Partitions

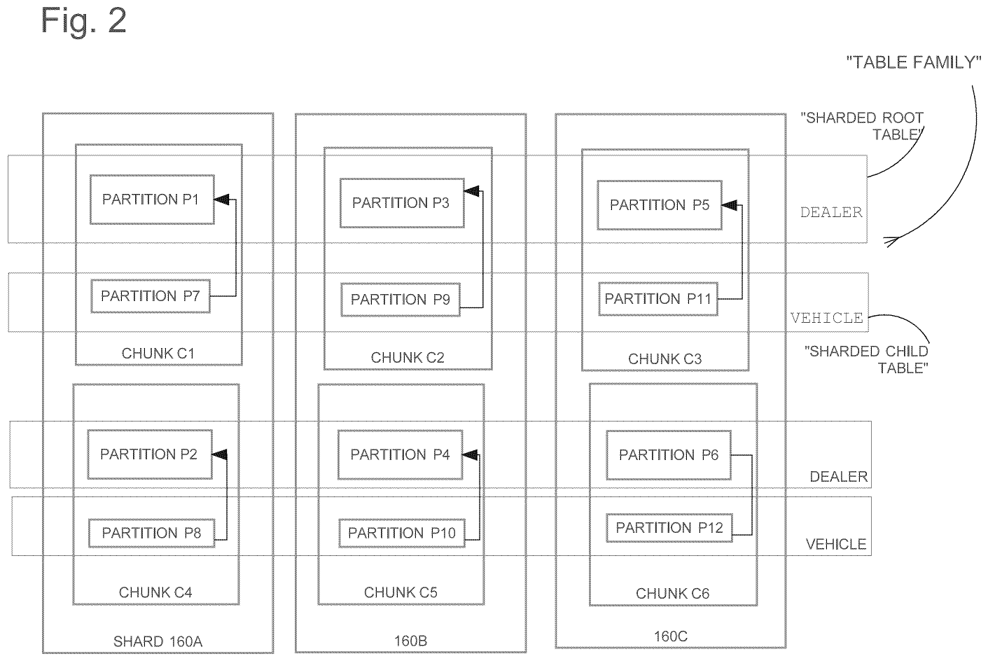

FIG. 2 depicts how tables of sharded database 150 are horizontally partitioned across shards 160. According to an embodiment, a sharded table is partitioned into table partitions (“partitions”). A partition comprises one or more sets of data blocks, where each set is stored contiguously in database persistent storage. One or more of a table's partitions are hosted on a separate shard.

FIG. 2 depicts sharded tables DEALER and VEHICLE; each of these sharded tables includes at least two partitions on each of shards 160. For example, DEALER includes partitions P1 & P2 on shard 160A, partitions P3 & P4 on shard 160B, and partitions P5 & P6 on shard 160C.

In an embodiment, sharding exploits the partitioning capabilities of a DBMS. In a DBMS, a table may be partitioned based on a partition key and a variety of partitioning techniques as follows. Under range partitioning, a partition is associated with one or more distinct ranges of partition key values. When a row having a partition key value is inserted, it is inserted into the partition that is associated with the range into which the partition key value falls. Under list partitioning, partitions are associated with a list of values. When a row having a partition key value is inserted, it is inserted into the partition that is associated with that list of values to which the partition key value belongs. Under hash partitioning, rows are distributed to partitions according to a hash scheme.

Dynamic sharding mapping leverages the partitioning capability of a DBMS to define partitions into which to split a sharded table. However, the rows of a sharded table are partitioned across the partitions according to a sharding key of the sharded table and a sharding distribution scheme defined in effect by a distributed sharding directory, as shall be described in greater detail.

### Table Families

In order to obtain the benefits of sharding, the schema of a sharded database should be designed in a way that maximizes the number of database commands that may be executed on a single shard rather than multiple shards. Executing a database command on a single shard rather than multiple shards improves efficiency.

Often, there is a parent-child relationship between database tables. For example, a referential constraint may exist between a parent table and a child table. Specifically, in the case of a foreign key constraint, a column of a child table may be constrained to only store values that exist in the primary key of the parent table. A “table family” is a representation of a hierarchy of related tables where the hierarchy is based on relationships between one or more parent tables and corresponding one or more child tables. A table in a table family that has no parent is called the “root table.” There is only one root table in a table family.

Tables DEALER and VEHICLE comprise a table family. DEALER is the root table and has a primary key. VEHICLE is a child table of DEALER that has a foreign column constrained to the primary key values of DEALER.

According to one embodiment, when sharding tables that belong to a table family, all of the child tables of a table family are partitioned by inheriting the sharding key from the root table of the table family. A child table of the parent table inherits the sharding key of the parent table and is partitioned in the same way as the parent in respective partitions for the child table. For each partition of a parent table, there is a corresponding partition for the child table partitioned by the inherited sharding key. A partition of the parent table is referred to as a parent partition, and the partition of the child table is referred to as a child partition; the parent partition and its corresponding child partition are referred to as parent and child with respect to each other. Finally, the sharding key of the root table is used as the sharding key for all tables in the table family.

Tables DEALER and VEHICLE are sharded into parent and child partitions. Partitions P7 & P8 are child partitions of parent partitions P1 & P2, respectively; partitions P9 & P10 are child partitions of parent partitions P3 & P4, respectively; partitions P11 & P12 are child partitions of parent partitions P5 & P6, respectively.

### Chunks

A chunk is a set of one or more tablespaces that are used to store one or more partitions of one or more sharded tables. A chunk may include a respective partition for one or more sharded tables. A tablespace comprises one or more data files that are used to store database data.

If a chunk includes a respective partition for multiple sharded tables, the partitions may be stored in the same tablespace or separate tablespaces of the chunk. A chunk may be organized such that partitions that are often accessed together are stored as a chunk on the same shard. In this way, the accesses to those partitions are optimized to occur on the shard that hosts the chunk.

A key example of organizing chunks in this way, for this reason, is a table family. A chunk can be used to store the parent table and its corresponding child partitions of a table family that is hosted on a shard. Chunk C1, C2, C3, C4, C5 and C6 include parent and corresponding child partitions P1 & P7, P3 & P9, P5 & P11, P2 & P8, P4 & P10 and P6 & P12, respectively.

Chunks provide a useful way to organize a set of related partitions into a set of tablespaces. Tablespaces can be relatively easily transported between databases. Because a chunk comprises one or more tablespaces, a chunk is easily transported between databases.

### Sharding Directory

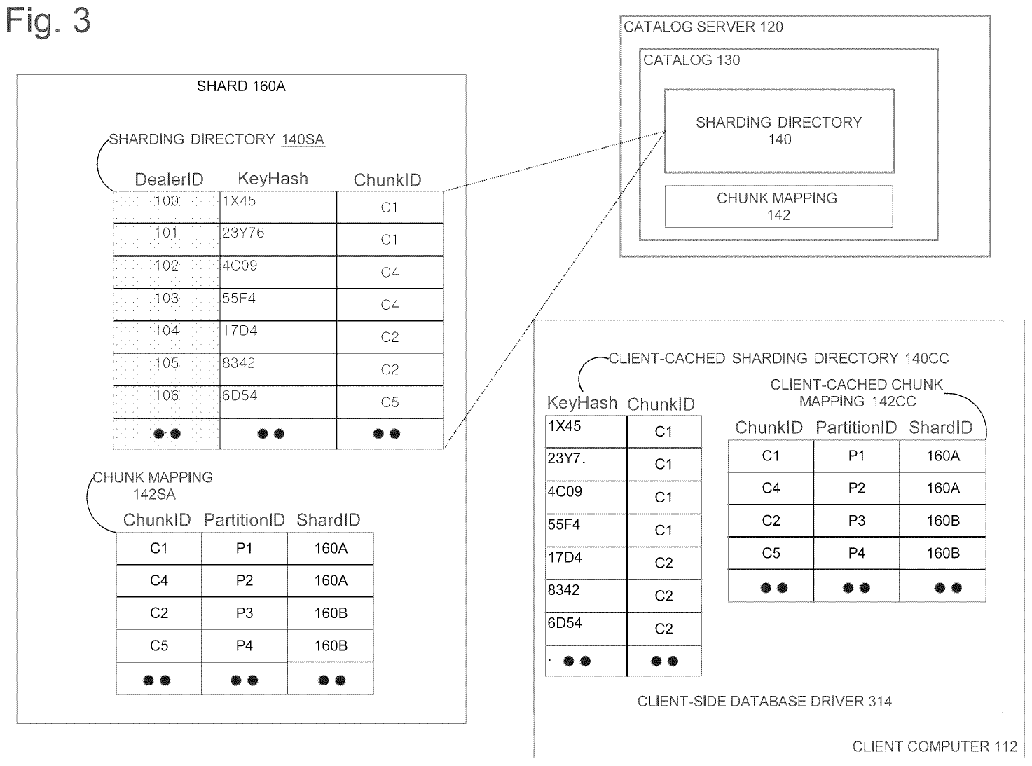

FIG. 3 depicts a sharding directory and chunk mapping according to an embodiment of the present invention. A sharding directory maps sharding key values to respective chunks; a chunk mapping maps chunks to partitions and shards. A sharding directory and chunk mapping are used together to resolve the partition and/or shard server that that is mapped to a sharding key. A sharding directory is a distributed structure that is replicated on shards and to a degree on client computers, such as shards 160 and client computer 112, respectively.

A replica of a data item does not mean the replica is necessarily an exact copy of the data item. A replica may include a copy of part of the data item or part of the data item in encoded or masked form.

FIG. 3 illustrates a sharding directory and chunk mapping by depicting sharding directory 140SA and chunk mapping 142SA, which are replicas of sharding directory 140 and chunk mapping 142, respectively. Sharding directory 140SA is a table comprising rows and columns. The rows of a sharding directory are referred to herein as a directory entry. Each directory entry in a sharding directory maps a sharding key value to a respective chunk.

Specifically, sharding directory 140SA columns includes primary key DealerID and columns KeyHash, and ChunkID. DealerID contains primary key values of table DEALER from the primary key column of table DEALER, which also has the column name DealerID (not shown). The primary key column DealerID of table DEALER is also the sharding key of the table DEALER. Hence, the column values stored in DealerID of sharding directory 140SA are sharding key values of table DEALER. ChunkID includes chunk identification values (chunk IDs) that uniquely identify a chunk in sharded DBMS 101. KeyHash is described in further detail later. The first directory entry in sharding directory 140SA includes in DealerID the sharding key value 100, thereby mapping the sharding key value to the chunk ID C1.

Chunk mapping 142SA is a table comprising rows and columns, each row being referred to herein as a chunk mapping entry. Each chunk mapping entry in Chunk Mapping 142SA maps a chunk to a partition of a sharded root table and to a shard that hosts the chunk. Specifically, columns of chunk mapping 142SA include ChunkID, PartitionID, and ShardID. ChunkID includes chunk IDs. PartitionID includes partition identification values (partition IDs) that uniquely identify a partition in sharded DBMS 101. ShardID includes shard identification values (shard IDs) that uniquely identify a shard in sharded DBMS 101. The first chunk mapping entry in chunk mapping 142SA maps chunk C1 to partition P1 and shard 160A.

Sharding directory 140SA is replicated on client computer 112 as client-cached sharding directory 140CC. A client-cached sharding directory is a private data structure of a client-side software component referred to herein as a client-side database driver. An application executing on a client computer system interacts with a DBMS via a client-side database driver that is accessible by computer processes executing the application on the client computer. The application includes invocations of routines (e.g., functions, procedures, object methods, remote procedures) of the shard component. The client-side database driver is configured for performing the detailed operations needed to interface with a DBMS, including a sharded DBMS. For example, an application invokes a function of client-side database driver 314 to establish a connection with sharded DBMS 101. The client-side database driver then handles the details of a connection on sharded DBMS 101.

Client-side database drivers are configured to use data structures that are private to the client-side database driver, that is, that are only accessible by computer processes on a client computer when executing the client-side database driver. Client-cached sharding directory 140CC is a private data structure of client-side database driver 314.

For purposes of data security, column DealerID of sharding directory 140SA is not replicated within client-cached sharding directory 140CC. Instead, only column KeyHash is replicated. Column KeyHash contains sharding key hash values. A sharding key hash value is generated by applying a hash function/algorithm to a sharding key value that produces a sufficiently unique hash value among other hash values generated for the sharding key values, and that makes it virtually impossible to derive the sharding key value from the hash value generated for the sharding key value.

Chunk mapping 142SA is also replicated on client computer 112 as client-cached chunk mapping 142CC. Client-cached chunk mapping 142CC is a private data structure of client-side database driver 314.

### Routing by Client-Side Database Driver

A client-side database driver is configured to receive requests to execute database commands on the sharded DBMS and route the database commands to a shard or the catalog server as appropriate. The client-side database driver may route the database command based on one or more routing parameters provided with the request. A routing parameter value may be a chunk ID or sharding key value. The client-side database driver looks up a parameter value in the client-cached sharding directory and/or the chunk mapping of the client-side database driver to find the shard identifier mapped to the parameter value. The client-side database driver then sends the database command to the shard identified by the shard identifier. For example, client application 100 invokes a function of client-side database driver 314 to request execution of a database command against DEALER, passing in a parameter that specifies the value 102 for the sharding key of DEALER. The client-side database driver applies a hash function/algorithm to generate the hash value 4C09. The client-side database driver looks up the hash value in client-cached sharding directory 140CC to find that the hash value is mapped to chunk ID C1, and looks up chunk ID C1 to find that chunk C1 is mapped to shard 160A, thereby determining the sharding key value is mapped to shard 160A. The client-side database driver sends the database command to shard 160A.

A client-side database driver is configured to parse database commands received from applications and direct database commands based on information parsed from the database command. For example, the client-side database driver may extract a sharding key value referenced by a predicate filter in the database command, lookup the shard identifier mapped to the sharding key value by the client-cached sharding directory and chunk mapping, and forward the database command to the shard identified by the shard identifier.

The above routing scenarios illustrate an advantage of a distributed sharding directory under dynamic shard mapping. The shard or other destination to which a database command is routed within a sharded DBMS may be resolved locally by a client-side database driver by performing a lookup in the client-side database driver's locally stored client-cached sharding directory and client-cached chunk mapping. This ability avoids additional latency that might otherwise be incurred to obtain routing information needed to route a database command by requesting a mapping over a network from a central source such as the catalog directory or sending the database command to the catalog server for redirection to the appropriate shard.

### Connection Pools

To send a database command to a shard or catalog server, a database connection to a database session of the shard or catalog server is needed. A client-side database driver obtains a database connection from a database connection pool. A database connection pool is a cache of database connections to database sessions that are on a DBMS, such as sharded DBMS 101. The database connections and database sessions are maintained so that the database connections can be securely reused to connect to a DBMS to access database objects in the DBMS. A database connection pool may contain respective separate sets of database connections to a set of DBMSs. The database connections are managed by a client-side database driver.

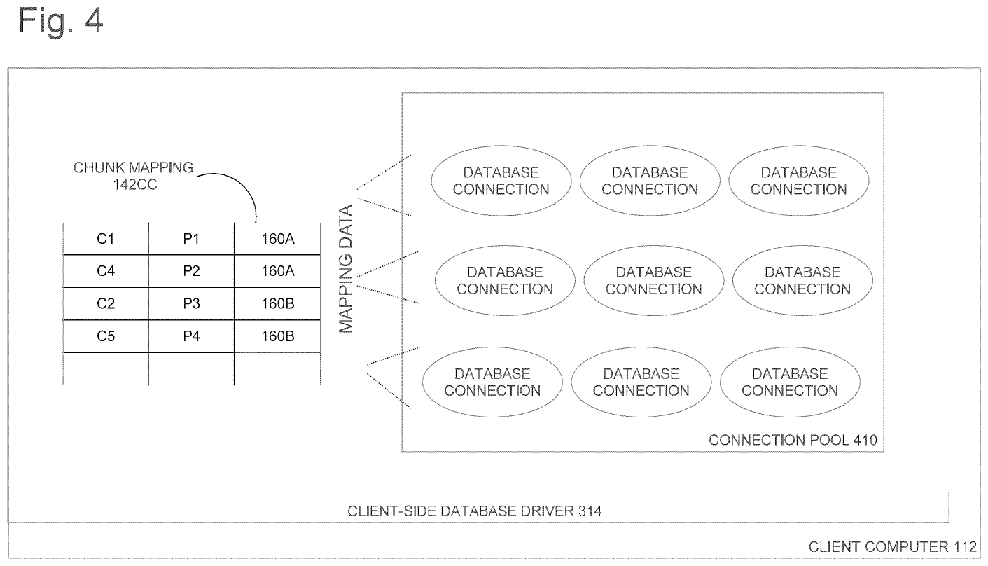

FIG. 4 depicts a connection pool according to an embodiment of the present invention. Referring to FIG. 4, it depicts connection pool 410 on client computer 112. Connection pool 410 includes a set of database connections to each of shards 160. Connection pool mapping data maps a shard ID of a shard to the shard's respective set of connections. The connection pool also includes database connections to the catalog server 120. Connection pool 410 is managed by client-side database driver 314. The data structures for connection pool 410, including the mapping data, are private to client-side database driver 314.

When the client-side database driver determines that a database command should be routed to a particular shard or to the catalog server, the client-side database driver uses the connection pool mapping data to find an available database connection to the shard or catalog server. The client-side database driver then uses the database connection in the connection pool to send the database command to the shard for execution by the shard.

### Dynamic Shard Mapping

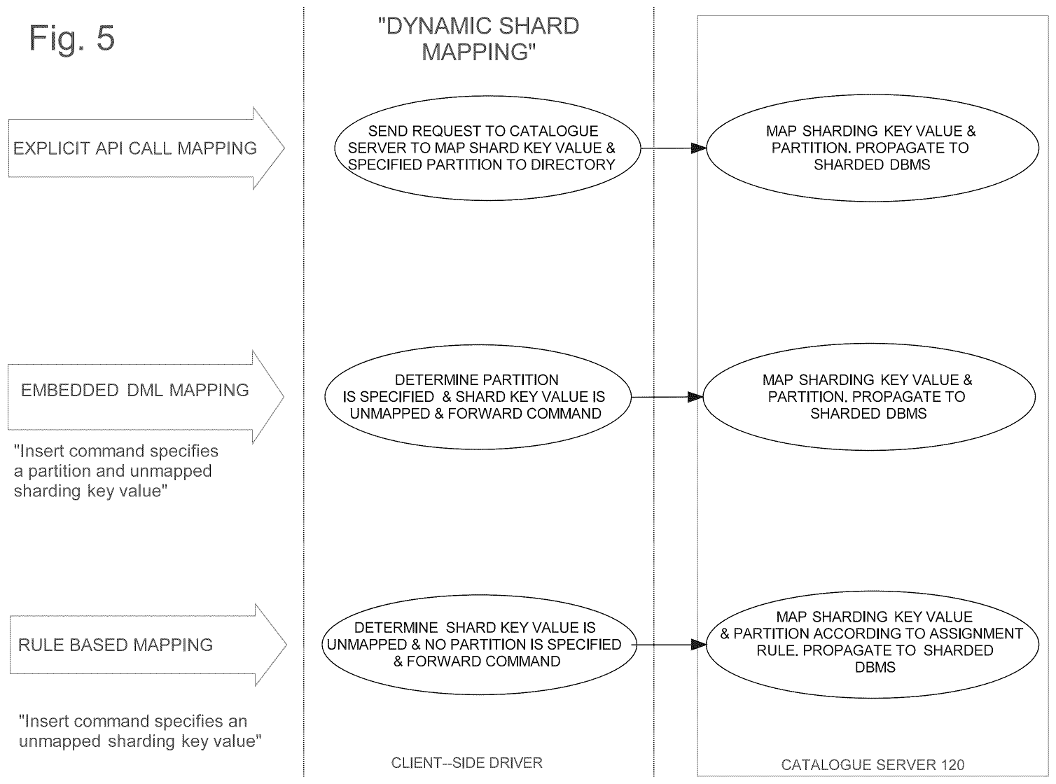

FIG. 5 depicts three ways to perform dynamic shard mapping. These are 1) explicit API call mapping, 2) embedded DML mapping, and 3) rule-based mapping. All three basic ways may be initiated by an application invoking an API function of the client-side database driver of shard 160. Several ways involve a client-side database driver examining the client-cached sharding directory on the client computer on which the client-side database driver is being executed.

### Explicit API Call Mapping

An application invokes a client-side database driver API specifying a sharding key value to which to map a partition. In response, the client-side database driver sends a request to send to catalog server 120 to map the sharding key value to the partition. The mapping is then propagated throughout sharded DBMS.

### Embedded DML Mapping

An application invokes an API of the client-side database driver to send a database command to insert a row into a root sharded table. The database command specifies a partition and an unmapped sharding key value, that is, a sharding key value that is not yet mapped by the client-cached sharding directory. For example, the database command is an insert database command that requests to insert a row into a root shard table and assign a value to a primary key, which is also a sharding key. The database command also includes a partition clause that identifies a partition into which to insert the row.

The client-side database driver parses the database command to extract the sharding key value. By examining the client-side database driver's client-cached sharding directory, the client-side database driver determines that the sharding key value is not mapped by the client-cached sharding directory. In response to this determination, the client-side database driver then determines that the database command identifies a partition in a partition clause to which to insert the row. The client-side database driver then forwards the database command to catalog server 120, which also parses the database command and determines that the sharding key value is unmapped and that the database command identifies the partition to which to insert the row. In response to this determination, catalog server 120 maps the sharding key value to the partition in catalog sharding directory 140 and propagates the directory entry throughout sharded DBMS 101. Catalog server 120 then forwards the database command to the shard server to which the sharding key value is mapped.

### Rule-Based Mapping

An unmapped sharding key value is mapped according to one or more rules in response to a database command to insert a row that specifies the unmapped sharding key value without specifying a partition to which to insert the row. According to an embodiment, a sharded DBMS may be configured to apply one or more native assignment rules that the sharded DBMS is configured to apply. Native assignment rules specify how to select a root table partition to map to a sharding key value.

An application invokes an API of the client-side database driver to send the database command. The driver parses the database command to extract the sharding key value. By examining the client-side database driver's client-cached sharding directory, the driver determines that the sharding key value is not mapped by the driver's client-cached sharding directory. In response to this determination, the driver then determines that the database command does not identify a partition to which to insert the row. The client-side database driver forwards the database command to the catalog server, which also parses the database command and determines, based on an examination of catalog sharding directory 140, that the sharding key value is unmapped and that the database command does not specify a partition to which to insert the row. In response to these determinations, the catalog server applies the native assignment rules to map the sharding key value to a partition in sharding directory 140 and then propagates the directory entry throughout the sharded DBMS.

A user may specify to apply one or more native assignment rules by issuing one or more database commands that are directed to a root sharded table and that specify a native assignment rule to apply. Examples of native assignment rules include random, round robin, and last partition added. For random, a partition is randomly selected. For round robin, a partition is selected in round robin manner. For the last partition added, the partition that was last added to the sharded root table is selected. In an embodiment, a native assignment rule may specify to use a user-defined function to select a partition. The user-defined function selects a partition by applying a user-defined function that selects a partition for a sharding key value.

### Propagating Changes to Distributed Sharding Directory

In an embodiment, changes made to a distributed sharded directory are propagated through a sharded DBMS through database commands issued by the catalog server to shards of a sharded DBMS. Under the embedded DML mapping approach or the rule-based mapping approach, the catalog server initiates the change to the copies of directory on both the catalog and/or the shard. At commit time, the change to the directory is then replicated to other shards.

A distributed sharding directory may be referred to as being changed by, for example, adding a directory entry or modifying a directory entry. In general, effecting the changes to the distributed sharding directory entails changing the sharding directory at the catalog server of the sharded DBMS and shard servers of the sharded DBMS.

Changes to client-cached copies of the distributed sharding directory are propagated in at least several ways. Client computers may subscribe to a notification channel through which a sharded DBMS sends notification of the changes. The client computers make changes to client-cached directories based on the change. Alternatively, when a client-side database driver connects to a shard server, the client-side database driver fetches a copy of the sharding directory.

### Sharding Key Remapping

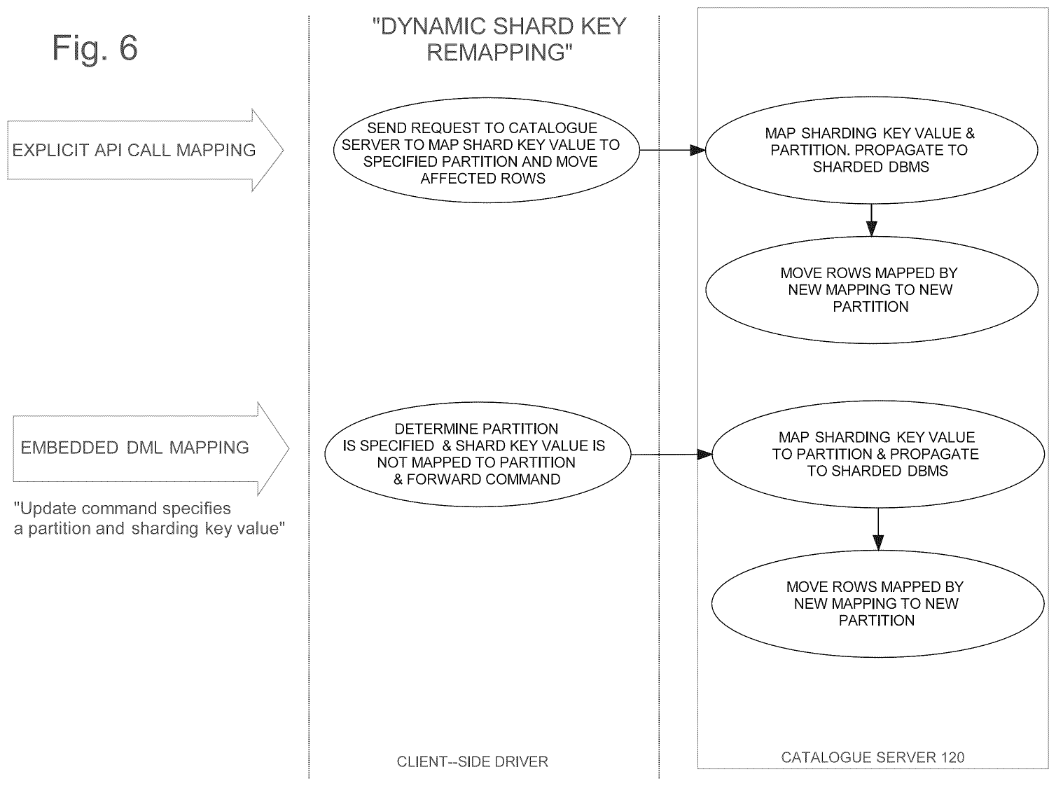

Sharding key remapping is an operation that maps a sharding key value already mapped to a partition to a new, different partition. Sharding key remapping may also move rows holding that sharding key value to the new partition. FIG. 6 depicts two ways of performing shard remapping dynamically. These are 1) explicit API call mapping and 2) embedded DML mapping.

### Explicit API Call Mapping

An application invokes a client-side drive API specifying a sharding key value to which to map a new partition. In response, the client-side database driver sends a request to catalog server 120 to map the sharding key value to the new partition.

In response, the catalog server maps the sharding key value of the row to the new partition by updating the directory entry for the sharding key value in sharding directory 140. Specifically, the directory entry is updated to map the chunk that corresponds to the new partition to the sharding key value. A chunk mapped to a partition is found by looking up the partition ID in the chunk mapping. The updated entry is then propagated throughout the sharded DBMS. The rows that have the matching sharding key value or inherited shading key value are moved to the new partition. The updating and propagation of the directory entry and the movement of the rows are performed within a database transaction, which is committed after the rows are moved.

### Embedded DML Mapping

An application invokes an API of the client-side database driver to send an update database command that specifies to update the partition of a row in a root sharded table. For example, the database command is an update SQL statement that includes a partition clause that identifies a new partition for the row.

The client-side database driver parses the database command to determine the database command specifies to update the partition of a row. In response to this determination, the client-side database driver then forwards the database command to catalog server 120, which, in response, parses the database command and determines that the database command specifies to update the partition of a row.

In response, the catalog server maps the sharding key value of the row to the new partition by updating the directory entry for the sharding key value in sharding directory 140, similarly as described previously. The directory entry is then propagated throughout the sharded DBMS. The row and the other rows that have a sharding key value for their sharding key or an inherited sharding key are moved to the new partition. The updating and propagation of the directory entry and the movement of the rows are performed within a database transaction, which is committed after the rows are moved.

### Moving Chunks & Partitions and Merging & Splitting A Partition

A chunk may be moved to a different shard, and partitions may be split or merged. Each of the operations may entail changing the distributed sharding director and/or distributed chunk mapping.

A chunk may be moved to a destination shard server. The directory entries mapping the chunk do not need to be changed. However, the distributed chunk mapping is changed to map the chunk and the partition to the destination shard server.

A partition is split by moving the subset of rows having a subset of the sharding key values to a new partition in a new chunk. The directory entries that map the subset of sharding key values are changed to map the sharding key values to the new chunk.

Partitions are merged by moving all the rows in a “source partition” to a destination partition in a destination chunk. The directory entries that map the set of sharding key values in the moved rows are changed to map the sharding key values to the destination chunk. The entry for source partition and chunk are removed from the chunk mapping.

### Partition Pruning Based on Dynamic Dictionary

Partition pruning is an optimization operation performed during query compilation to reduce the amount of data that needs to be accessed for the database command being compiled. Partition pruning entails evaluating the database command to determine that the data required to be accessed is limited to one or more partitions and then compiling the database command into an execution plan that only accesses the one or more partitions. The compilation may involve rewriting a database statement that specifies which partitions to access. During the execution of the database statement, access is limited to those partitions.

The determination of what data is accessed is based on a partition key value mapping and a filter predicate in the database command that is based on the partition key. The partition key value mapping may be read from serialized schema metadata that defines the partitions. A partition key value mapping maps partition key values to partitions in a database object. For example, under range partitioning, a partitioning key value mapping is stored as serialized schema metadata that maps ranges of partition key values to partitions. For hash partitioning, partition key value mappings are stored as serialized schema metadata that maps ranges of hash values of a hash function/algorithm to partitions.

However, in an embodiment of the present invention, the partition key value mapping is read and derived from a sharding directory and chunk mapping instead of serialized schema metadata. Furthermore, partition pruning is performed based on the sharding key.

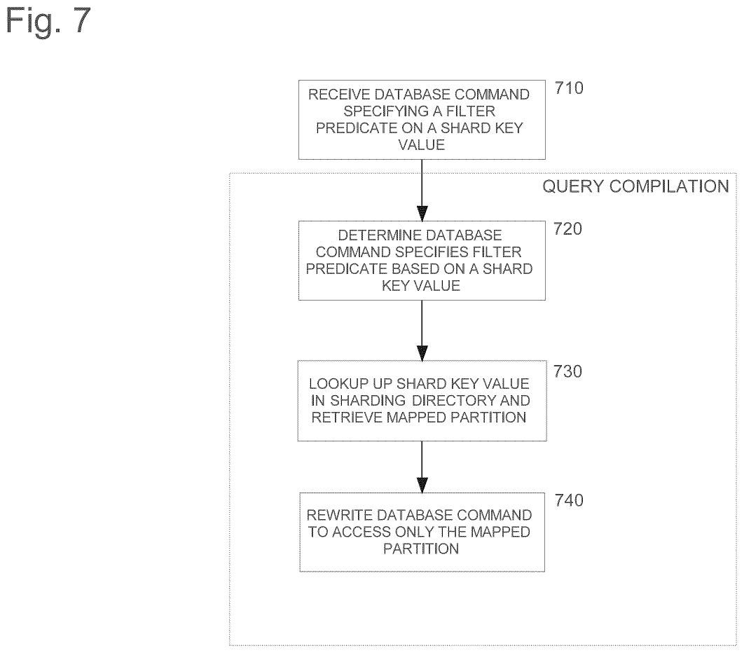

FIG. 7 depicts a procedure performed during query compilation to perform partition pruning. The procedure uses partition key value mapping derived from a sharding directory and chunk mapping.

The procedure is illustrated by an example that involves shard 160A receiving a database command routed to shard 160A by catalog server 120. (710) The database command accesses the table DEALER and includes the filter predicate “DealerID=102”, which is based on the sharding key of DEALER. DealerID is also the primary key and sharding key of DEALER.

As part of performing query compilation on the database command, shard 160A determines that the database command includes the predicate based on sharding key value 102. (720) In response, shard 160A looks up in sharding directory 140SA the sharding key value and finds that chunk C4 is mapped to the sharding key value 102 and looks in chunk mapping 142SA to find that partition P2 is mapped to chunk C4. (730) Shard 160A then rewrites the database command to only access partition P2. (740)

### Dynamic Shard Mapping in Other Kinds of DBMSS & Architectures

As mentioned before, dynamic shard mapping may be used in other kinds of databases other than relational databases. A database object may be various forms of a collection of records. In a DOCS, the records in a collection are documents. Hence, a sharded database object may be a sharded collection of documents that are sharded into partitions that store a subset of the collection. A sharding key may be a field in the collection of records.

In an embodiment, a database object may be heterogeneous in that the records of the database object may not include the same fields or columns. For example, a collection of documents may include a field that serves as a sharding key, but a subset of the documents of the collection may include one or more fields not included in other documents of the collection.

Rather than dedicating a specialized server such as catalog server 120 that performs certain functions within a sharded DBMS described above, the duties and functions of a catalog server may be distributed among the shard servers of sharded DBMS. These duties and functions include the maintenance of the catalog, which may be distributed among some or all of the shard servers, who coordinate the modifications to the catalog. A shard server that receives from a user a database command that requires only data from another shard server may route the database command to that other shard server. If the database command requires data from multiple shard servers, the shard server receiving the database command may send database commands to the other shard servers to process their respective share of the required data and return results to the shard server.

### DBMS Overview

A database management system (DBMS) manages a database. A DBMS may comprise one or more database servers. A database comprises database data and a database dictionary that is stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

A database command may also be in the form of an API call. The call may include arguments that each specifies a respective parameter of the database command. The parameter may specify an operation, condition, and target that may be specified in a database statement. A parameter may specify, for example, a column, field, or attribute to project, group, aggregate, or define in a database object.

In a DOCS, a database command may be in the form of functions or object method calls that invoke CRUD (Create Read Update Delete) operations. Create, update, and delete operations are analogous to insert, update, and delete operations in DBMSs that support SQL. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. java file) and the compiled version of the class (i.e., class file).

Native data types are data types supported by a DBMS “out-of-the-box”. Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data types and to be processed by a DBMS in database statements. In general, database software of a DBMS is programmed to recognize and process native data types without configuring the DBMS to do so by, for example, defining a data type by issuing DDL statements to the DBMS.

### Hardware Over View

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

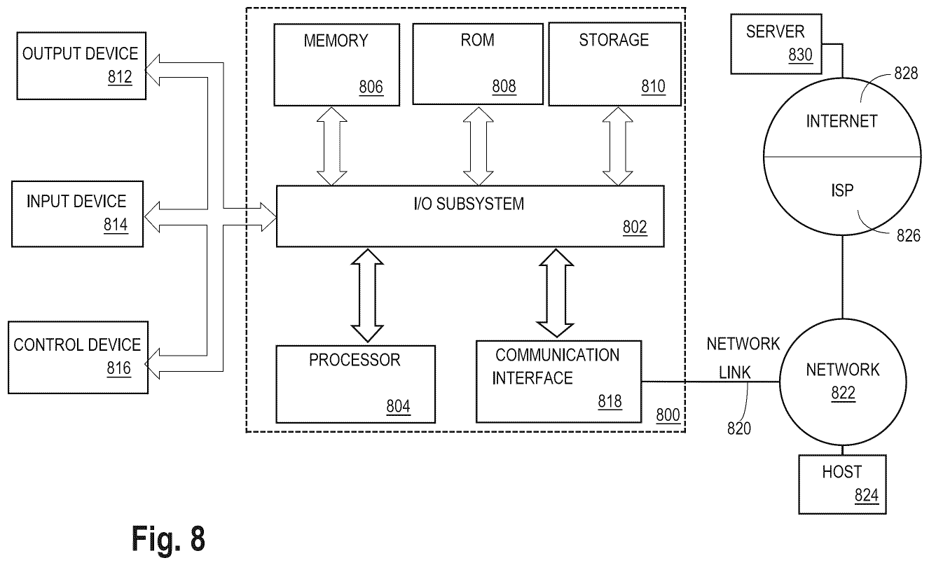

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Software Overview

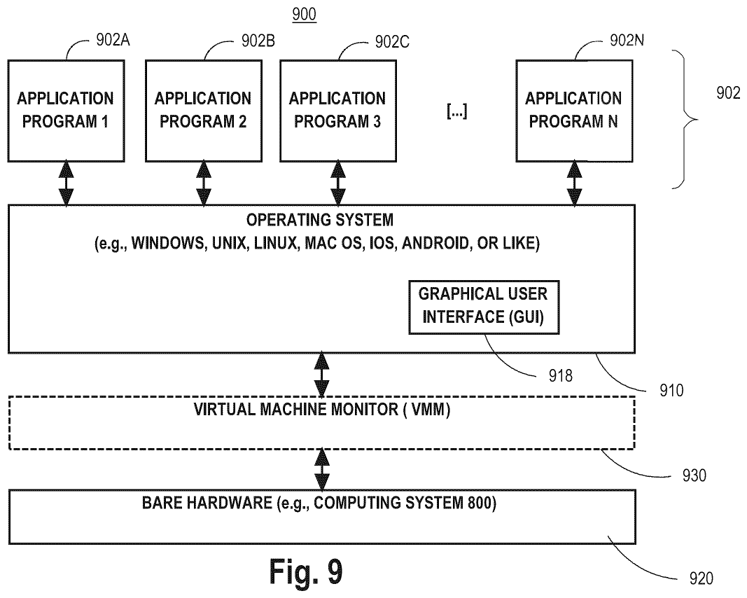

FIG. 9 is a block diagram of a basic software system 900 that may be employed for controlling the operation of computer system 800. Software system 900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 900 is provided for directing the operation of computer system 800. Software system 900, which may be stored in system memory (RAM) 1106 and on fixed storage (e.g., hard disk or flash memory) 1110, includes a kernel or operating system (OS) 910.

The OS 910 manages low-level aspects of computer operation, including managing execution of processes, memory allocation, file input and output (I/O), and device I/O. One or more application programs, represented as 902A, 902B, 902C . . . 902N, may be “loaded” (e.g., transferred from fixed storage 1110 into memory 1106) for execution by the system 900. The applications or other software intended for use on computer system 800 may also be stored as a set of downloadable computer-executable instructions, for example, for downloading and installation from an Internet location (e.g., a Web server, an app store, or other online service).

Software system 900 includes a graphical user interface (GUI) 915, for receiving user commands and data in a graphical (e.g., “point-and-click” or “touch gesture”) fashion. These inputs, in turn, may be acted upon by the system 900 in accordance with instructions from operating system 910 and/or application(s) 902. The GUI 915 also serves to display the results of operation from the OS 910 and application(s) 902, whereupon the user may supply additional inputs or terminate the session (e.g., log off).

OS 910 can execute directly on the bare hardware 920 (e.g., processor(s) 1104) of computer system 800. Alternatively, a hypervisor or virtual machine monitor (VMM) 930 may be interposed between the bare hardware 920 and the OS 910. In this configuration, VMM 930 acts as a software “cushion” or virtualization layer between the OS 910 and the bare hardware 920 of the computer system 800.

VMM 930 instantiates and runs one or more virtual machine instances (“guest machines”). Each guest machine comprises a “guest” operating system, such as OS 910, and one or more applications, such as application(s) 902, designed to execute on the guest operating system. The VMM 930 presents the guest operating systems with a virtual operating platform and manages the execution of the guest operating systems.

In some instances, the VMM 930 may allow a guest operating system to run as if it is running on the bare hardware 920 of computer system 800 directly. In these instances, the same version of the guest operating system configured to execute on the bare hardware 920 directly may also execute on VMM 930 without modification or reconfiguration. In other words, VMM 930 may provide full hardware and CPU virtualization to a guest operating system in some instances.

In other instances, a guest operating system may be specially designed or configured to execute on VMM 930 for efficiency. In these instances, the guest operating system is “aware” that it executes on a virtual machine monitor. In other words, VMM 930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method, comprising:
a first shard server in a sharded DBMS receiving a first database command specifying sharding key value that is not mapped by a distributed sharding directory of the sharded DBMS;
in response to receiving said first database command, adding a particular entry to said distributed sharding directory that maps said sharding key value to a first shard identifier;
after adding said particular entry to said distributed sharding directory:
receiving a second database command referencing said sharding key value; and
based on said particular entry and said sharding key value referenced in said second database command, routing said second database command to a particular shard server of said sharded DBMS that corresponds to said first shard identifier.

2. The method of claim 1, wherein the sharding key value is a key of a database object comprising a collection of records, wherein the database object is one of:
a relational table comprising rows as records; and
a collection of documents comprising documents as records, each document of said collection conforming to a hierarchical markup language.

3. The method of claim 1, wherein said first database command references a partition identifier, wherein adding a particular entry includes determining that said particular entry should map said sharding key value to said first shard identifier based on said partition identifier.

4. The method of claim 3, wherein said first database command is a data manipulation statement.

5. The method of claim 1, further including:
said first shard server receiving a particular database command specifying a particular sharding key value that is mapped by a particular entry in said distributed sharding directory to a particular shard identifier, said particular database command specifying a change to a record in a sharded database object stored in said sharded DBMS; and
in response to receiving said particular database command, modifying said particular entry to map said particular sharding key value to a different shard identifier.

6. The method of claim 1, wherein adding a particular entry includes determining that said particular entry should map said sharding key value to said first shard identifier based on one or more native assignment rules defined for a sharded table.

7. The method of claim 1, further including:
receiving a particular database command issued against a particular sharded database object; and
when compiling said second database command, performing partition pruning based on said distributed sharding directory.

8. The method of claim 7, wherein a definition for said particular sharded table specifies no partition key value mapping for said particular sharded table.

9. The method of claim 1, wherein:
said distributed sharding dictionary includes a respective copy of said distributed sharding dictionary on each shard server of a plurality of shard servers of said sharded DBMS;
said plurality of shard servers includes a second shard server;
routing said second database command includes said second shard server routing said second database command by at least looking up said sharding key value in a respective copy of the distributed sharding dictionary that is stored at said second shard server to determine that said sharding key value is mapped to said particular sharded server.

10. The method of claim 1, wherein:
a particular client computer of said particular shard server is connected via a network with said particular shard server; and
wherein said particular client computer stores a particular copy of said distributed sharding directory.

11. The method of claim 10, wherein routing said second database command includes said particular client computer routing said second database command by at least looking up said sharding key value in the particular copy of the distributed sharding dictionary to determine that said sharding key value is mapped to said first sharded identifier.

12. The method of claim 1, wherein the sharding key value is a sharding key of a database object, wherein the database object is partitioned into a plurality of partitions, each partition of said plurality of partitions being contained within a respective chunk of a plurality of chunks, each chunk of said plurality of chunks being hosted on a respective shard server of said sharded DBMS, wherein the method comprises:
performing a split, move, or merge operation on a particular partition of said plurality of partitions;
modifying said distributed sharding directory to reflect said operation.

13. One or more computer-readable non-transitory media storing one or more sequences of instructions that, when executed by computing devices, cause:
a first shard server in a sharded DBMS receiving a first database command specifying sharding key value that is not mapped by a distributed sharding directory of the sharded DBMS;
in response to receiving said first database command, adding a particular entry to said distributed sharding directory that maps said sharding key value to a first shard identifier;
after adding said particular entry to said distributed sharding directory:
receiving a second database command referencing said sharding key value; and
based on said particular entry and said sharding key value referenced in said second database command, routing said second database command to a particular shard server of said sharded DBMS that corresponds to said first shard identifier.

14. The one or more computer-readable non-transitory media of claim 13, wherein the sharding key value is a key of a database object comprising a collection of records, wherein the database object is one of:
a relational table comprising rows as records; and
a collection of documents comprising documents as records, each document of said collection conforming to a hierarchical markup language.

15. The one or more computer-readable non-transitory media of claim 13, wherein said first database command references a partition identifier, wherein adding a particular entry includes determining that said particular entry should map said sharding key value to said first shard identifier based on said partition identifier.

16. The one or more computer-readable non-transitory media of claim 15, wherein said first database command is a data manipulation statement.

17. The one or more computer-readable non-transitory media of claim 13, wherein the one or more sequences of instructions include instructions that, when executed by one or more computing devices, cause:
said first shard server receiving a particular database command specifying a particular sharding key value that is mapped by a particular entry in said distributed sharding directory to a particular shard identifier, said particular database command specifying a change to a record in a sharded database object stored in said sharded DBMS; and
in response to receiving said particular database command, modifying said particular entry to map said particular sharding key value to a different shard identifier.

18. The one or more computer-readable non-transitory media of claim 13, wherein adding a particular entry includes determining that said particular entry should map said sharding key value to said first shard identifier based on one or more native assignment rules defined for a sharded table.

19. The one or more computer-readable non-transitory media of claim 13, wherein the one or more sequences of instructions include instructions that, when executed by one or more computing devices, cause:
receiving a particular database command issued against a particular sharded database object; and
when compiling said second database command, performing partition pruning based on said distributed sharding directory.

20. The one or more computer-readable non-transitory media of claim 19, wherein a definition for said particular sharded table specifies no partition key value mapping for said particular sharded table.

21. The one or more computer-readable non-transitory media of claim 13, wherein:
said distributed sharding dictionary includes a respective copy of said distributed sharding dictionary on each shard server of a plurality of shard servers of said sharded DBMS;
said plurality of shard servers includes a second shard server;
routing said second database command includes said second shard server routing said second database command by at least looking up said sharding key value in a respective copy of the distributed sharding dictionary that is stored at said second shard server to determine that said sharding key value is mapped to said particular sharded server.

22. The one or more computer-readable non-transitory media of claim 13, wherein:
a particular client computer of said particular shard server is connected via a network with said particular shard server; and
wherein said particular client computer stores a particular copy of said distributed sharding directory.

23. The one or more computer-readable non-transitory media of claim 22, wherein routing said second database command includes said particular client computer routing said second database command by at least looking up said sharding key value in the particular copy of the distributed sharding dictionary to determine that said sharding key value is mapped to said first sharded identifier.

24. The one or more computer-readable non-transitory media of claim 13, wherein the sharding key value is a sharding key of a database object, wherein the database object is partitioned into a plurality of partitions, each partition of said plurality of partitions being contained within a respective chunk of a plurality of chunks, each chunk of said plurality of chunks being hosted on a respective shard server of said sharded DBMS, wherein The one or more computer-readable non-transitory media comprises:
performing a split, move, or merge operation on a particular partition of said plurality of partitions;
modifying said distributed sharding directory to reflect said operation.
